(19) United States
(12) Patent Application Publication
(10) Pub. No.: US 2018/0110065 A1
(43) Pub. Date: Apr. 19, 2018

(54) Method of Handling Uplink Scheduling for Wireless Communication System

(71) Applicant: MEDIATEK INC., Hsin-Chu (TW)

(72) Inventors: Ying-You Lin, Taoyuan City (TW); Hung-Wen Yang, Hsinchu City (TW); Chih-Kun Chang, New Taipei City (TW)

(21) Appl. No.: 15/782,870

(22) Filed: Oct. 13, 2017

Related U.S. Application Data
(60) Provisional application No. 62/408,078, filed on Oct. 14, 2016.

(51) Int. Cl. H04W 72/12; H04W 74/08

(52) U.S. Cl. CPC H04W 72/1268; H04W 74/0816; H04W 28/22; H04W 72/1252; H04W 72/1289

(57) ABSTRACT

A method of handling uplink (UL) scheduling for an access point of a wireless communication system includes obtaining UL performance metrics of a UL queue comprising a plurality of UL transmissions; determining at least one back-off parameter of the UL queue according to the UL performance metrics; and transmitting a trigger frame of triggering the UL transmissions according to the at least one back-off parameter.

### CROSS REFERENCE TO RELATED APPLICATIONS

This application claims the benefit of U.S. Provisional Application No. 62/408,078 filed on 2016 Oct. 14, the contents of which are incorporated herein in their entirety.

### BACKGROUND

The present invention relates to a method for a wireless communication system, and more particularly, to a method of handling uplink scheduling for an access point of a wireless communication system.

IEEE 802.11 is a set of media access control (MAC) and physical layer (PHY) specifications for implementing wireless local area network (WEAN) communication in the unlicensed (2.4, 3.6, 5, and 60 GHz) frequency bands. The standards and amendments provide the basis for wireless network products using the unlicensed frequency bands. For example, IEEE 802.11ac is a wireless networking standard in the 802.11 family to provide high-throughput WLANs on the 5 GHz band. Significant wider channel bandwidths (20 MHz, 40 MHz, 80 MHz, and 160 MHz) were proposed in the IEEE 802.11ac standard.

One key feature of IEEE 802.11ax is uplink (UL) multi-user multiple-in-multiple-out (MU-MIMO) which allows multiple users (stations) to upload data to an access point (AP) simultaneously. According to the specifications of the IEEE 802.11ax, the AP transmits a trigger frame to multiple stations to inform the multiple stations of transmitting uplink (UL) data in a subsequent period at the same time. However, the specifications of the IEEE 802.11ax do not specify timings of transmitting the trigger frame and the AP may encounter an issue of fairness and efficiency when scheduling the UL and downlink (DL) transmissions. For example, when the AP communicates with stations STA_A and STA_B, the AP is required to transmit DL data to the station STA_A and the station STA_B needs to transmit UL data to the AP, wherein the DL data and the UL data have the same queue length and the same priority. Under such a condition, the AP cannot decide to send the trigger frame for the UL data or to transmit the downlink data to the station STA_A when considering the fairness problem between the stations STA_A and STA_B. Thus, how to determine the timings of transmitting the trigger frame for the UL transmissions becomes a topic to be discussed.

### SUMMARY

In order to solve the above problem, the present disclosure provides a method of handling uplink (UL) scheduling for an access point of a wireless communication system.

In an aspect, the present disclosure discloses a method of handling uplink (UL) scheduling for an access point of a wireless communication system. The method includes obtaining UL performance metrics of a UL queue comprising a plurality of UL transmissions; determining at least one back-off parameter of the UL queue according to the UL performance metrics; and transmitting a trigger frame of triggering the UL transmissions according to the at least one back-off parameter.

In another aspect, the present disclosure discloses a method of handling transmission scheduling for an access point of a wireless communication system. The method comprises obtaining UL performance metrics of a UL queue; determining at least one back-off parameter of the UL queue according to the UL performance metric; determining whether an internal collision occurs between the UL queue and at least one downlink queue; selecting one of the UL queue and the at least one DL queue according to the UL performance metric and DL performance metrics of the at least one DL queue when the internal collision occurs; transmitting a trigger frame triggering UL transmissions of the UL queue when selecting the UL queue and when the internal collision does not occur; and transmitting DL data of the selecting DL queue when selecting the at least one DL queue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless local area network (WLAN) communication system according to an example of the present invention.

FIG. 2 is a schematic diagram of a communication apparatus according to an example of the present invention.

FIG. 3 is a flowchart of a process according to an example of the present invention.

FIG. 4 is a schematic diagram of a system structure according to an example of the present invention.

FIG. 5 is a flowchart of a process according to an example of the present invention.

### DETAILED DESCRIPTION

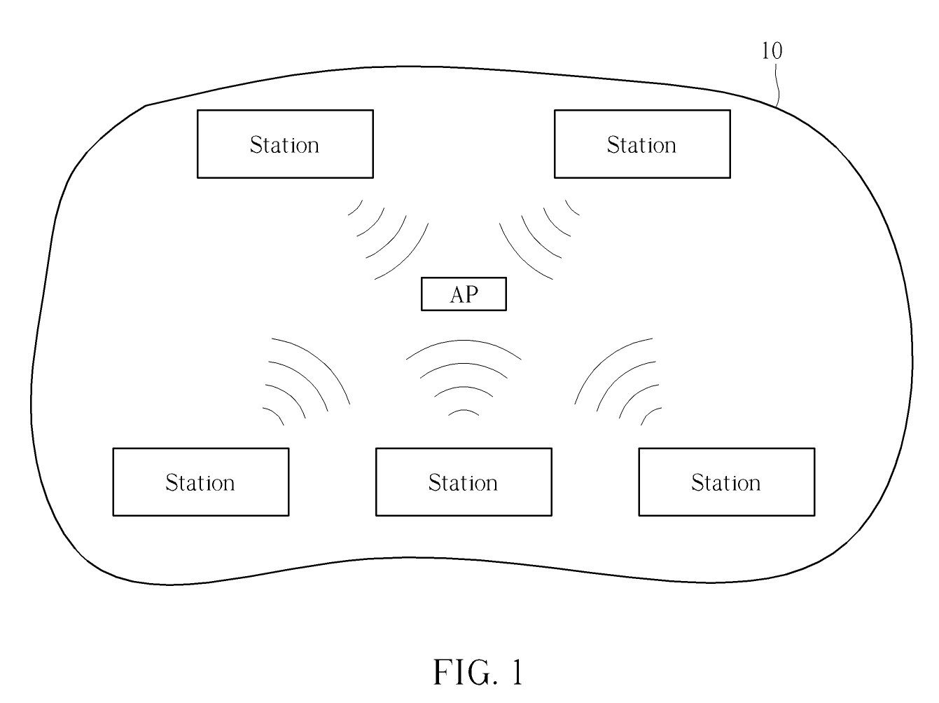

Please refer to FIG. 1, which is a schematic diagram of a wireless local area network (WLAN) communication system 10 according to an example of the present invention. The WLAN communication system 10 is briefly composed of a plurality of stations (e.g. communication devices such as smart phones, tablets, laptops, etc.), and one (or more) of the communication device in this example, which controls communications, channel establishment, radio resource arrangement, etc. of other communication devices, is an access point (AP). The AP and the stations are simply utilized for illustrating the structure of the WLAN communication system 10, which is well known in the art. Since a station can also be operated in a soft access point (soft-AP) mode, the AP in the present invention is not limited to a physical access point. Any wireless devices operating as an access point is within the scope of the present invention.

The AP and the stations may be equipped with multiple antennas for performing beamforming, to realize massive multiple-input multiple-output (MIMO) or time-reversal division multiple access (TRDMA). That is, beam sectors may be formed by the antennas according to the massive MIMO or the TRDMA. Energy of the signals (e.g., received signals and/or transmitted signals) may be separated and focused within corresponding beam sectors. The stations may be divided into multiple groups of stations, and each group of stations belongs to a corresponding one of the beam sectors. Thus, the advantage of spatial focusing effect may be provided to the stations, when the massive MIMO or the TRDMA is operated. It should be noted that complexity of a station may be further reduced if the AP performs a transmission to the station according to the TRDMA. For example, the station may need only one receive antenna to perform a reception from the network according to the TRDMA. According to the above description, multiple-user MIMO (MU-MIMO) is realized between the AP and the stations shown in FIG. 1.

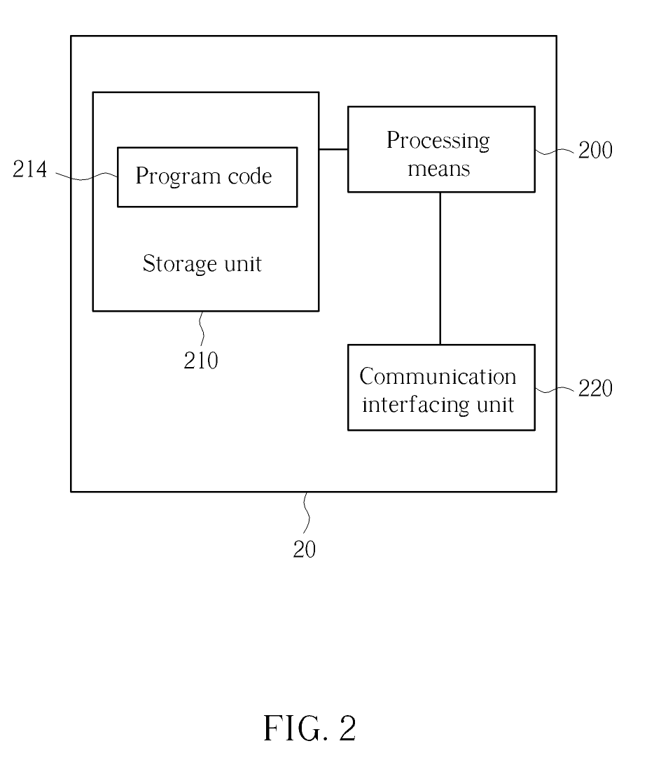

FIG. 2 is a schematic diagram of a communication apparatus 20 according to an example of the present invention. The communication apparatus 20 may be the AP or any of the stations shown in FIG. 1, but is not limited herein. The communication apparatus 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage unit, non-transitory computer-readable medium (e.g., tangible media), etc. The communication interfacing unit 220 is preferably a transceiver and is used to transmit and receive signals (e.g., data, signals, messages and/or packets) according to processing results of the processing means 200.

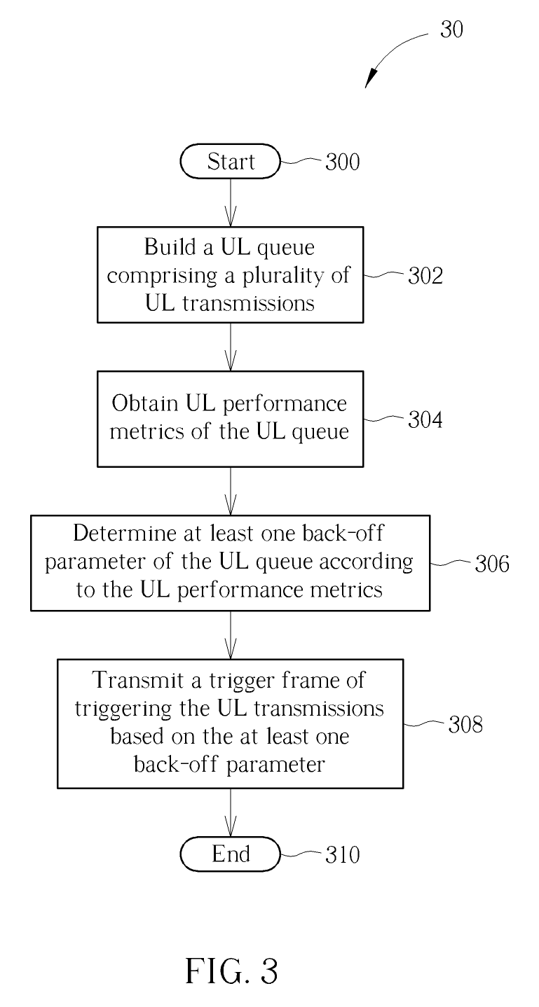

Please refer to FIG. 3, which is a flowchart of a process 30 according to an example of the present invention. The process 30 may be utilized in an AP of a wireless communication system for handling Uplink scheduling of the wireless communication system. The process 30 may be utilized in the AP shown in FIG. 1 and compiled into the program code 214. As shown in FIG. 3, the process 30 includes the following steps:

Step 300: Start.

Step 302: Build a UL queue comprising a plurality of UL transmissions.

Step 304: Obtain UL performance metrics of the UL queue.

Step 306: Determine at least one back-off parameter of the UL queue according to the UL performance metrics.

Step 308: Transmit a trigger frame of triggering the UL transmissions based on the at least one back-off parameter.

Step 310: End.

According to the process 30, the AP builds a UL queue comprising a plurality of UL transmissions. In an example, the UL transmissions are corresponding to the same station. That is, the AP may build a UL queue for each of the stations connected to the AP. In another example, the UL transmissions are corresponding to all of the stations connected to the AP. In other words, the AP builds only one UL queue. Similar to downlink (DL) transmissions that are classified into 4 access categories voice (VO), video (VI), best effort (BE) and background (BG), the UL transmissions of the UL queue may be corresponding to one of the access categories VO, VI, BE and BG. In this example, the AP builds 4 UL queues for each of the access categories VO, VI, BE and BG. According to different applications and design concepts, the number of UL queues built by the AP may be appropriately altered and is not limited to the above examples. After building the UL queue, the AP obtains UL performance metrics of the UL transmissions and accordingly determines at least one back-off parameter (e.g. Enhanced Distributed Channel Access Function (EDCAF) parameters such as the minimum contention window CWmin, the maximum contention window CWmax and the arbitration inter frame spacing number (AIFSN)) of the UL queue. Based on the at least one back-off parameter, the AP determines timings of transmitting a trigger frame of triggering the UL transmissions.

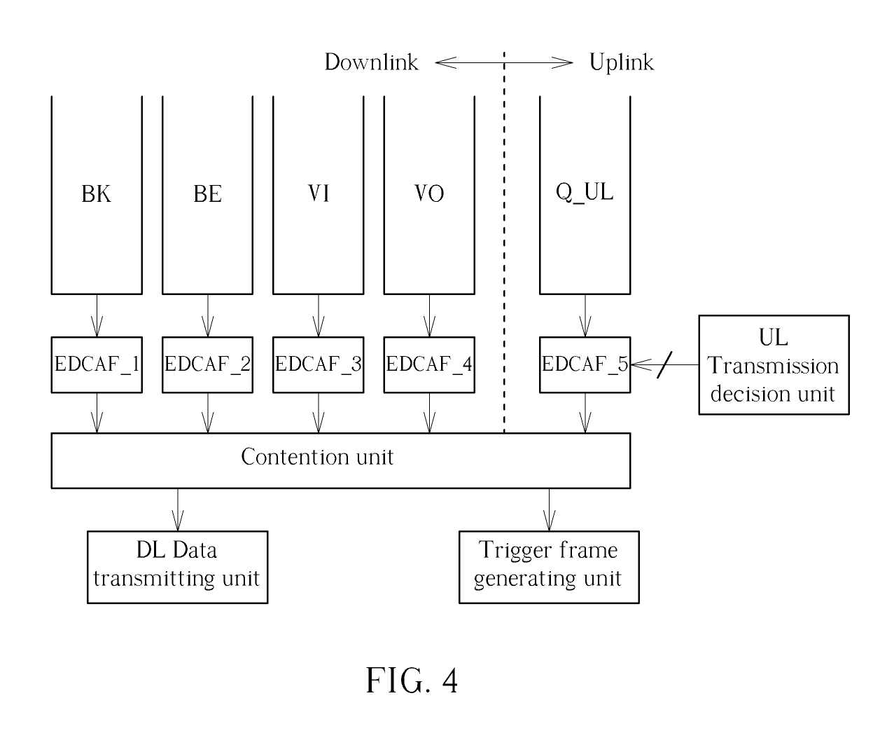

As to the details of the process 30, please refer to FIG. 4 that is a schematic diagram of a system structure according to an example of the present invention. As shown in FIG. 4, DL transmissions are mapped into 4 DL queues Q_BK, Q_BE, Q_VI, and Q_VO corresponding to 4 access categories BK, BE, VI, and VO, respectively, and UL transmissions are included in a UL queue Q_UL. For example, the AP may acquire information of all UL transmissions through buffer status reports from the stations connected to the AP and maps the UL transmissions into the UL queue Q_UL. Note that, the AP may generate multiple UL queues Q_UL according to different applications and design concepts. That is, the number of the UL queues built by the AP is not limited to 1 and FIG. 4 only shows the UL queue Q_UL for illustrations. In this example, each of the DL queues Q_BK, Q_BE, Q_VI and Q_VO and the UL queue Q_UL has its own enhanced distribute channel access function (EDACF) unit and the back-off parameters of the EDACF units EDACF_1-EDCAF_5, such as the minimum contention window CWmin, the maximum contention window CWmax and the AIFSN, are determined independently. In FIG. 4, the back-off parameters of the EDCAF unit EDCAF_5 are generated by a UL transmission decision unit and units of determining the back-off parameters of the EDCAD units EDCAF_1-EDCAF_4 are omitted for brevity. Each of the EDCAD units EDCAF_1-EDCAF_5 is utilized to generate an output of indicating priority of its own transmissions to a contention unit. Based on outputs of the EDCAD units EDCAF_1-EDCAF_5, the contention unit determines whether an internal collision occurs among the DL queues Q_BK, Q_BE, Q_VI, and Q_VO, and the UL queue Q_UL, and selects one of the DL queues Q_BK, Q_BE, Q_VI, and Q_VO, and the UL queue Q_UL. If the contention unit selects the UL queue Q_UL, a trigger frame generating unit transmits a trigger frame of triggering the UL transmissions; and if the contention unit selects one of the DL queues Q_BK, Q_BE, Q_VI, and Q_VO, DL data of the selected DL queue are transmitted by a DL data transmitting unit.

In an example, the UL transmission decision unit obtains a queue length of the UL queue Q_UL as one of the UL performance metrics and accordingly determines the at least one back-off parameter of the UL queue Q_UL. When the queue length of the UL queue Q_UL is greater, the UL transmission decision unit adjusts the back-off parameter to increase the priority of the UL queue Q_UL; otherwise, the UL transmission decision unit adjusts the back-off parameter to decrease the priority of the UL queue Q_UL. For example, the UL transmission decision unit decreases the minimum contention window CWmin, the maximum contention window CWmax and/or the AIFSN to increase the priority of the UL queue Q_UL, and does the opposites to decrease the priority of the UL queue Q_UL.

In another example, the UL transmission decision unit obtains traffic priorities of UL transmissions belonging to the UL queue Q_UL and accordingly determines the at least one back-off parameter of the UL queue Q_UL. In this example, the UL transmission decision unit adjusts the at least one back-off parameter to increase the priority of the UL queue Q_UL when the UL queue Q_UL has more UL transmissions of higher traffic priority (e.g. the UL transmissions of voice and/or video).

In an example, the AP obtains a ratio between the number N_UL of stations corresponding to the UL transmissions and the number N_DL of the stations corresponding to DL transmissions as one of the UL performance metrics. When the ratio between the numbers N_UL and N_DL increases, the AP adjusts the at least one back-off parameter to decrease the priority of the UL queue; otherwise, the UL transmission decision unit adjusts the at least one back-off parameter to increase the priority of the UL queue. As a result, the AP is able to balance the DL transmissions and the UL transmissions.

In an example, the UL transmissions included in the UL queue Q_UL are corresponding to the same station STA_C. In this example, the UL transmission decision unit obtains at least one channel condition (e.g. a packet error rate, a packet success rate, and a transmission rate) of the channel between the AP and the station STA_C and accordingly determines the at least one back-off parameter. When the at least one channel condition becomes better (e.g. the packet error rate decreases, the packet success rate increases and/or the transmission rate increases), the UL transmission decision unit adjusts the at least one back-off parameter to increase the priority of the UL queue Q_UL; otherwise, the UL transmission decision unit adjusts the at least one back-off parameter to decrease the priority of the UL queue Q_UL. Furthermore, the UL transmission decision unit may record transmission airtime of the station STA_C (i.e. the time consuming on the transmissions between the AP and the station STA_C) as one the UL performance metrics. When the transmission airtime of the station STA_C is greater, the UL transmission decision unit adjusts the at least one back-off parameter to decrease the priority of the UL queue Q_UL, to achieve airtime fairness among the stations connected to the AP.

In an example, the UL transmissions included in the UL queue are corresponding to stations STA_AX supporting the IEEE 802.11ax. In this example, the AP acquires a ratio between the number N_AX of the stations STA_AX and the number N_AC of stations STA_AC that supports the IEEE 802.11ac but does not support the IEEE 802.11ax. Because the AP cannot control behaviors of the stations STA_AC contending their own UL transmissions, the UL transmission decision unit adjusts the at least one back-off parameter to increase the priority of the UL queue Q_UL when the ratio between the numbers N_AX and N_AC decreases and to decrease the priority of the UL queue Q_UL when the ratio between the numbers N_AX and N_AC increases. The throughput of the stations STA_AX and that of the stations STA_AC can be balanced, therefore.

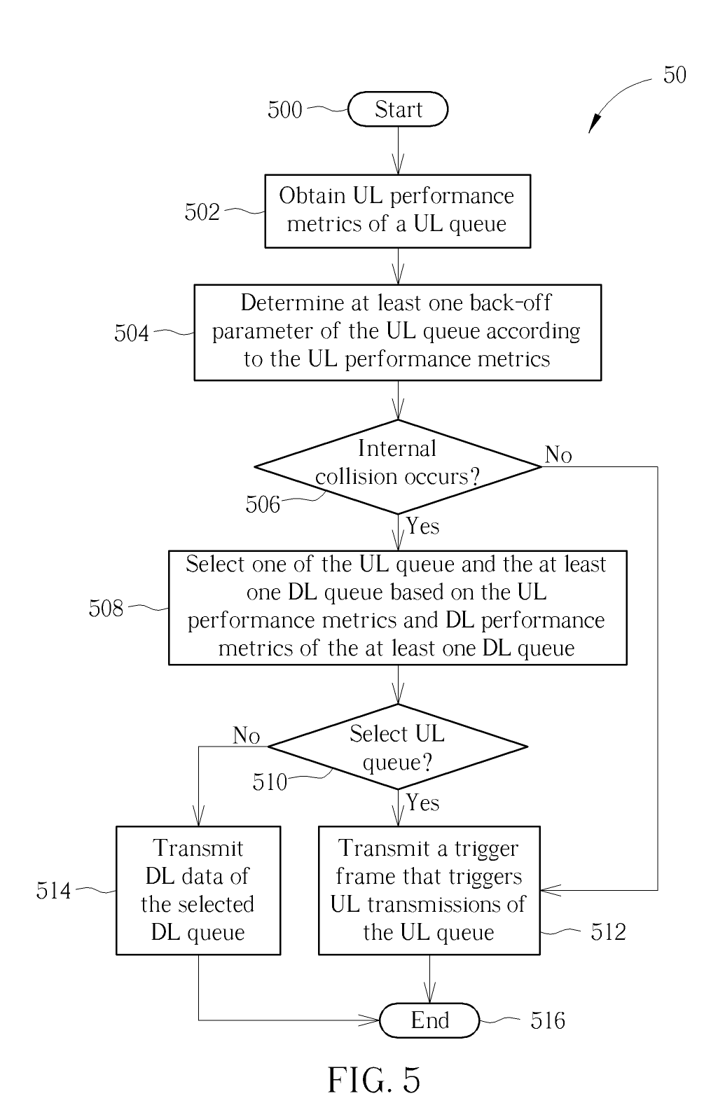

Please refer to FIG. 5, which is a flowchart of a process 50 according to an example of the present invention. The process 50 is utilized to handle transmission scheduling for the AP of the wireless transmission system. The process 50 may be compiled into the program code 214 and comprises the following steps:

Step 500: Start.

Step 502: Obtain UL performance metrics of a UL queue.

Step 504: Determine at least one back-off parameter of the UL queue according to the UL performance metrics.

Step 506: Determine whether an internal collision between the UL queue and at least one DL queue occurs. If yes, perform step 508; otherwise, perform step 512.

Step 508: Select one of the UL queue and the at least one DL queue based on the UL performance metrics and DL performance metrics of the at least one DL queue.

Step 510: Determine whether selecting the UL queue. If yes, perform step 512; otherwise, perform step 514.

Step 512: Transmit a trigger frame that triggers UL transmissions of the UL queue.

Step 514: Transmit DL data of the selected DL queue.

Step 516: End.

According to the process 50, the AP obtains UL performance metrics of a UL queue. In an example, the UL queue comprises UL transmissions corresponding to a specific station (e.g. the abovementioned station STA_C). In another example, the UL queue comprises UL transmissions corresponding to all stations connected to the AP. In still another example, the UL queue comprises UL transmissions corresponding to one of 4 access categories BG, BE, VI, and VO. In addition, the UL performance metrics obtained by the AP may be at least one of a queue length of the UL queue, traffic priorities of the UL transmissions belonging to the UL queue, a ratio between the number of stations corresponding to the UL transmissions and the number of the stations corresponding to DL transmissions, at least one channel condition of the UL transmissions included in the UL queue, transmission airtime of each station connected to the AP, and a ratio between the number of the stations supporting IEEE 802.11ax and the number of stations that supports the IEEE 802.11ac but does not support the IEEE 802.11ax.

After obtaining the UL performance metrics, the AP accordingly determines at least one back-off parameter of the UL queue. The at least one back-off parameter comprises at least one of the minimum contention window CWmin, the maximum contention window CWmax, and the AIFSN. Next, the AP determines whether an internal collision occurs between the UL queue and at least one DL queue (e.g. the DL queue Q_BK, Q_BE, Q_VI, and Q_VO) based on the back-off parameters of the UL queue and the at least one DL queue. If there is not the internal collision, the AP transmits a trigger frame of triggering the UL transmissions of the UL queue.

If the internal collision occurs, the AP selects one of the UL queue and the at least one DL queue based on the UL performance metrics and DL performance metrics of the at least one DL queue to select one of the collided queues. For example, the AP may compare traffic priorities of the collided queues. In an example of the UL queue is corresponding to the access category VI and the UL queue collides with the DL queue of the access category BE, the AP compares the traffic priorities and accordingly selects the UL queue because the access category VI has higher traffic priority. In another example, the AP compares queue lengths of the collided queues and selects the queue with greater queue length. In still another example, the AP compares airtimes consuming on the collided queues and selects the queue having less airtimes to achieve the airtime fairness. In yet another example, the AP compares channel conditions of the collided queues and selects the queue with better channel conditions, to maximize the throughput.

If the UL queue is selected, the trigger frame of triggering UL transmissions of the UL queue is transmitted. If the DL queue is selected, DL transmissions of the selected DL queue are performed to transmit DL data of the selected DL queue.

Those skilled in the art should readily make combinations, modifications and/or alterations on the abovementioned description and examples. In addition, the abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication apparatus 20.

In the present disclosure, the AP builds the UL queue for handling UL scheduling. Based on the UL performance metrics of the UL queue, the AP appropriately adjusts the back-off parameters of the UL queue and is able to determine the timing of transmitting the trigger frame of triggering the UL transmissions of the UL queue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling uplink (UL) scheduling for an access point of a wireless communication system, the method comprising:
obtaining UL performance metrics of a UL queue comprising a plurality of UL transmissions;
determining at least one back-off parameter of the UL queue according to the UL performance metrics; and
transmitting a trigger frame of triggering the UL transmissions according to the at least one back-off parameter.

2. The method of claim 1, wherein the UL transmissions are corresponding to at least one UL station of the wireless communication system.

3. The method of claim 2, wherein the UL performance metrics comprise at least one of a ration between a number of the at least one UL station and a number of downlink stations, transmission time configured to the at least one UL station, a packet error rate, a packet success rate, and a transmission rate of the at least one UL station.

4. The method of claim 1, wherein the UL transmissions are corresponding to one of access categories background, best effort, voice, and video.

5. The method of claim 1, wherein the UL performance metrics comprise at least one of a queue length of the UL queue, traffic priorities of the UL transmissions, and a ratio between a number of stations supporting IEEE 802.11ax and a number of stations supporting IEEE 802.11ac but not supporting IEEE 802.11ax.

6. The method of claim 1, wherein the at least one back-off parameter comprises at least one the minimum contention window, the maximum contention window, and arbitration inter frame spacing number (AIFSN).

7. A method of handling transmission scheduling for an access point of a wireless communication system, the method comprising:
obtaining uplink (UL) performance metrics of a UL queue;
determining at least one back-off parameter of the UL queue according to the UL performance metric;
determining whether an internal collision occurs between the UL queue and at least one downlink queue;
selecting one of the UL queue and the at least one DL queue according to the UL performance metric and DL performance metrics of the at least one DL queue when the internal collision occurs;
transmitting a trigger frame triggering UL transmissions of the UL queue when selecting the UL queue and when the internal collision does not occur; and
transmitting DL data of the selecting DL queue when selecting the at least one DL queue.

8. The method of claim 7, wherein the UL transmissions are corresponding to at least one UL station of the wireless communication system.

9. The method of claim 8, wherein the UL performance metrics comprise at least one of a ration between a number of the at least one UL station and a number of downlink stations, transmission time configured to the at least one UL station, a packet error rate, a packet success rate, and a transmission rate of the at least one UL station.

10. The method of claim 7, wherein the UL transmissions are corresponding to one of access categories background, best effort, voice, and video.

11. The method of claim 7, wherein the UL performance metrics comprise at least one of a queue length of the UL queue, traffic priorities of the UL transmissions, and a ratio between a number of stations supporting IEEE 802.11ax and a number of stations supporting IEEE 802.11ac but not supporting IEEE 802.11ax.

12. The method of claim 7, wherein the at least one back-off parameter comprises at least one the minimum contention window, the maximum contention window, and arbitration inter frame spacing number (AIFSN).
